(19) United States
(12) Patent Application Publication
(10) Pub. No.: US 2009/0102088 A1
(43) Pub. Date: Apr. 23, 2009

(54) METHOD FOR MOLDING WASTE PLASTIC AND METHOD FOR THERMAL DECOMPOSITION OF PLASTIC

(76) Inventors: Tetsuharu Ibaraki, Chiba (JP); Tsuneo Koseki, Chiba (JP); Yuuji Tooda, Chiba (JP); Takashi Hiromatsu, Chiba (JP); Yasuhiko Mori, Fukuoka (JP); Syuuichi Shiozawa, Chiba (JP); Masatoshi Sakatani, Chiba (JP); Takashi Sato, Fukuoka (JP)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/298,746

(22) PCT Filed: Nov. 13, 2006
(86) PCT No.: PCT/JP2006/323041

§ 371 Date: Oct. 27, 2008

(30) Foreign Application Priority Data
Apr. 27, 2006 (JP) 2006-122860

(51) Int. Cl. B29C 47/88; C10B 53/07

(52) U.S. Cl. 264/211.13; 201/5

(57) ABSTRACT

Exemplary embodiments of the present invention can be directed to producing high-density pellets by molding waste plastic and to producing high-strength coke by mixing the pellets with coal and dry-distilling the mixture in a coke oven. As feedstock is used waste plastic that contains polyethylene, polypropylene and polystyrene, which are plastics that soften at a low temperature, at a total rate of about 50% or greater. The waste plastic is molded using a molding method of extruding it from a nozzle of a screw-type stuffing machine. In the method of this invention, the waste plastic can be heated to about 180˜260° C. in the molding machine and gas in the molding machine is sucked out. By this operation, the polyethylene, polypropylene and/or polystyrene are made molten and the amount of gas in the plastic is reduced. The plastic in this state is compression-molded by extrusion from a nozzle of about 15˜60 mm diameter. The plastic molding obtained can be cut into chunks and cooled with a water cooler within about 3 seconds after cutting.

### CROSS-REFERENCE TO RELATED APPLICATION(S)

This application is a national stage application of PCT Application No. PCT/JP2006/323041 which was filed on Nov. 13, 2006, and published on Nov. 8, 2007 as International Publication No. WO 2007/125626 (the “International Application”). This application claims priority from the International Application pursuant to 35 U.S.C. §365, and from Japanese Patent Application No. 2006-122860 filed Apr. 27, 2006, under 35 U.S.C. §119. The disclosures of the above-referenced applications are incorporated herein by reference in their entities.

### FIELD OF THE INVENTION

The present invention relates to a method of processing waste plastic, including refuse plastics such as scrap plastic occurring in the processing of plastic and used container/packaging plastic, and in particular to a method for processing waste plastic into high-density pellets. The present invention further relates to a recycling method, e.g., a method for obtaining fuel gas, oily matter, and coke by thermal decomposition and vaporization of the pellets in a coke oven.

### BACKGROUND INFORMATION

Conventionally, scrap plastic arising in the processing of plastic and used plastic (at times referred to herein collectively as “waste plastic”) has been incinerated or used as landfill. Disposal by incineration damages the incinerator because of the high incineration temperature. Incineration may also have a problem of generating dioxin through reaction between co-present chlorine and hydrocarbons produced during burning. One exemplary problem with disposal of plastic as landfill is that the reclaimed land can be low in utility value because the failure of the plastic to decompose can prevent the ground from becoming firm.

Various forms of plastic recycling have been introduced to address the issue of plastic disposal. For example, conversion of plastic to oil or gas has been attempted. However, such conversion has not yet proved as practical because of the high processing cost. In contrast, thermal decomposition and vaporization of plastic in a coke oven can be an economical method facilitating high volume recycling. As thermal decomposition and vaporization in a coke oven can yield fuel gas and oily products, as well as coke, it can be a good method from the point of view of a diverse applicability.

The thermal decomposition and vaporization method generally consists in mixing waste plastic with coal, charging the mixture into a coke oven, and conducting dry distillation at about 1,200 C. This method is described in, for example, Japanese Patent Publication (A) No. S48-34901. Although the yields can vary with the type of plastic used, about 15˜20% of the plastic can be converted to coke, about 25˜40% to oily products, and about 40% to coke oven gas (gas composed chiefly of hydrogen and methane). The coke derived from the plastic is discharged from the coke oven as mixed with coke derived from the coal. The composite coke is used as a reducing agent or fuel in a blast furnace, ferroalloy production process or the like.

The method of thermal decomposition and vaporization waste plastic in a coke oven is an effective way of economically recycling of plastic. However, accurate information regarding the relationship between the method of using the plastic and the coke quality has not been yet available. The quality of the coke produced has therefore been a problem. For example, the technique used to recover considerable amounts of gas or tar using the disclosure of Japanese Patent Publication (A) No. H8-157834 provides likely no consideration to the coke quality, so that when a large quantity of plastic is mixed in, the coke produced is low in strength. Coke can be used in blast furnaces, cupolas and other large-scale equipment and must be able to withstand the load conditions in such furnaces. Poor coke strength can therefore be a critical quality issue.

Used plastic from households etc. may be utilized for recycling after separating out non-plastic trash. Actually, however, the amount of mixed-in extraneous matter can be high, so that the ash content can sometimes be as high as 10%. Since the moldability is therefore likely poor, the shape of the pellets may be poor and the apparent specific gravity can be low.

Japanese Patent Publication (A) No. 2000-372017 states that this problem can be overcome by thermal decomposition and vaporizing a mixture of coal and waste plastic pellets of predetermined size and high density. The high-density plastic pellets used may preferably have an apparent density of 0.4˜0.95 kg/L. Thus, an improvement using a method for increasing waste plastic pellets density has been carried out previously.

Thus, in plastic recycling using a coke oven as previously described, the method has been adopted of mixing coal and high-density waste plastic pellets, as described in Japanese Patent Publication (A) No. 2000-372017, and using the mixture in a coke oven. As this method conducts molding without melting, the periphery of the cut face is inevitably fuzzy. The fuzzy region lowers the bulk density (spatial volume occupied by the pellet aggregate divided by the total mass of the pellets), and degrades the flow of the pellet aggregate. The pellet bridging that occurs as a result may sometimes make it impossible to cut the pellet aggregate out of the storage tank and cause other problems. Another problem is a generation of a significant amount of powder due to the detachment of the fuzzy regions from the main body.

The apparent density of pellets (individual pellet mass divided by pellet volume) produced by ordinary methods is usually 0.6˜0.7 g/cm³, and at most about 0.8 g/cm³. Even by utilizing a particular method such as one using a nozzle of small diameter (3˜5 mm), it has likely not been possible to achieve an apparent density of 0.95 g/cm³ or greater. The favorable effect on high-density coke production is therefore limited, and achievement of higher densities is desired.

Although the advantage of increasing the density of waste plastic pellets has been understood, good results have not always been realized. A need is therefore felt for a new technique for overcoming this problem. This invention provides a new technique that solves the foregoing problem by overcoming the drawbacks of the prior art method when producing dense plastic pellets from waste plastic and thermal decomposition and vaporizing them in a coke oven.

On the other hand, there is also known a conventional method of melting certain types of plastic and extruding the melt from a nozzle to produce a high-density plastic product. For instance, there is known the method of injecting plastic into molds as described in Japanese Patent Publication (A) No. H05-77301. Although the method described in this publication facilitates a production of a high-density plastic shaped article, such production can be slow and may have high cost associated therewith because it is performed by injecting molten plastic into molds. So it is not suitable as a means for producing waste plastic pellets. Therefore, there may be a need to provide a method suitable for waste plastic processing that can provide high in productivity and may facilitate processing at low cost.

Accordingly, there may be a need to address and/or overcome at least some of the deficiencies described herein above.

### SUMMARY OF EXEMPLARY EMBODIMENTS OF THE INVENTION

Exemplary embodiments of the present invention are provided to, e.g., overcome the issues described above.

For example, according to a first exemplary embodiment of the present invention, method and arrangement can be provided which can utilize feedstock as waste plastic that can be a mixture of multiple types of plastic containing at least one thermoplastic resin selected from among polyethylene, polypropylene and polystyrene, which are plastics that soften at a low temperature, in a total amount accounting for about 50% or greater of the mixture. The waste plastic can be molded using an exemplary embodiment of a molding method for extruding such waste plastic from a nozzle of a screw-type stuffing machine. In the method according to the exemplary embodiment of the present invention, the waste plastic can be heated to about 180˜260° C. in a molding machine. Gas in the molding machine can be sucked out in this condition. By this exemplary operation, the polyethylene, polypropylene and/or polystyrene can be melted, and the amount of gas in the plastic may be reduced. The plastic in this state can be compression-molded by extrusion from a nozzle of about 15˜60 mm diameter. The plastic molding obtained by this exemplary method may be cut into chunks and cooled with a water cooler within, e.g., about 3 seconds after cutting. The plastic pellets produced by this exemplary method can have few internal voids and may have a good internal void pattern free of large independent voids.

According to a second exemplary embodiment of the present invention, when used as feedstock, the waste plastic can be used that may be a mixture of multiple types of plastic containing polyethylene, polypropylene and/or polystyrene in a total amount accounting for about 50% or greater of the mixture and can further include the exemplary waste plastic containing chlorine-containing plastic (hereinafter sometimes called “chlorinated resin”) in an amount of not greater than 4 mass % on a chlorine mass ratio basis, the first exemplary embodiment of the method uses as still higher state control accuracy. This can be because of a preference to appropriately control hydrogen chloride generated from the chlorinated resin and requires rigorous control of the depressurization condition. For example, under the temperature condition set out in the first exemplary embodiment of the method according to the present invention, the suction pressure in the vessel holding the waste plastic can be reduced to about 0.1˜0.35 atm (e.g., absolute pressure), and, starting from this condition, an ejection from about 15˜60 mm diameter nozzle can be conducted to obtain a plastic molding by compression molding, thereby obtaining plastic pellets in a condition suitable for use in the coke oven. It can be desirable to utilize this exemplary method when the chlorine-containing plastic content ratio is about 0.5% or greater on a chlorine basis.

According to another exemplary embodiment of the present invention, the produced pellets can be cooled in the water cooler to a surface temperature of about 80° C. or less within about 2 seconds. Further, the waste plastic can be molded using a molding machine having a single stuffing screw and equipped with about 2˜8 nozzles, whereas the sum of the nozzle diameters (e.g., nozzle diameter×number of nozzles) can be ¼ or less of the circumferential length of the stuffing screw. In addition, the waste plastic can be molded using a molding machine having a pair of stuffing screws and equipped with about 2˜8 nozzles, whereas the sum of the nozzle diameters (nozzle diameter×number of nozzles) can be about ⅙ or less of the sum of the circumferential lengths of the stuffing screws.

According to still another exemplary embodiment of the present invention, plastic pellets can be used that have, e.g., no holes or cracks passing from the surface into the interior and can have an apparent density of about 0.85˜1.1 g/cm³. The volume of the pellets can preferably be about 6,000˜200,000 cubic mm. The pellets can be mixed with coking coal of an average pellet size of about 5 mm or less, and the mixture can be supplied to a coke oven. After thermal decomposition and vaporization is conducted, coking can continues for about 15˜24 hours to thermally decompose the waste plastic and combustible gases, e.g., mostly hydrogen and methane, as well as oily products constituted of hydrocarbon compounds. Such exemplary method can be used when the thermal decomposition and vaporization residue is recovered as coke.

In a further exemplary embodiment of the present invention, a method can be used for thermal decomposition of waste plastic. Such exemplary method can comprise mixing plastic pellets with coal and thermal decomposition, and vaporizing the mixture in a coke oven. For example, the maximum length of each individual pore present in a plastic pellet may likely be no greater than the cube root of the plastic pellet volume, and individual pore volume may be no greater than about 10% of the plastic pellet volume. Further, it is possible to mix with coal about 6,000˜200,000 cubic mm pellets produced by the exemplary method for molding the waste plastic and the thermal decomposition and vaporizing the mixture in the coke oven. In addition, e.g., the mixing ratio of plastic pellets to coal can be about 5 mass % or less.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figure showing illustrative embodiment(s), result(s) and/or feature(s) of the exemplary embodiment(s) of the present invention, in which:

FIG. 1 is an overall block diagram of an equipment for processing waste plastic according to an exemplary embodiment of the present invention;

FIG. 2 is a side cross-sectional view an exemplary embodiment of a waste plastic molding machine for implementing the exemplary embodiment of the present invention;

FIG. 3 is a side cross-sectional view of a water cooler for cooling waste plastic pellets extruded from a molding machine for implementing the exemplary embodiment of the present invention and having fluidity;

FIG. 4 is an illustration of an internal structure of a pellet produced by the exemplary embodiment of the present invention;

FIG. 5 is a side view of structure and contents of a coke oven carbonization chamber according to an exemplary embodiment of the present invention; and

FIG. 6 is a graph showing exemplary results of an analysis into how coke strength varies as a function of pellet mixing ratio for cokes produced from mixtures obtained by mixing coal and pellets of various volumes.

While the certain exemplary embodiments of the present invention will now be described in detail with reference to the figures, it is done so in connection with the illustrative embodiments.

### DETAILED DESCRIPTION OF EXEMPLARY EMBODIMENTS

Exemplary embodiments of the present invention relate to, e.g., processing the waste plastic that can be a mixture of multiple kinds of plastic pieces. The source materials can generally be waste plastic in the form of containers/packaging and other articles of daily use discarded from households, and miscellaneous waste plastic discarded from factories and the like. Such waste plastic can be a mixture of plastic pieces of various types and may be formed into a feedstock containing thermoplastic resin, e.g., at least one of polyethylene, polypropylene and polystyrene, at the rate of about 50 mass %. When total amount of the feedstock is melted, intense adhesion, persistence of large pores in the molding, and other problems arise during molding. The exemplary maximum melting rate can therefore be preferably made about 90 mass %. Moreover, molding is preferably conducted after crushing the waste plastic because molding is easier when the maximum length of the pieces is about 50 mm or less.

The waste plastic generally includes extraneous matter, so it is preferable to carry out an extraneous matter removal operation before or after crushing. The amount of inorganic matter entrained is preferably kept to 5 mass % or less in order to prevent deterioration of extrusion property during molding. In practice, however, a reduction of the amount of entrained inorganic matter to 0.5 mass % or less difficult to achieve and the presence of a higher content does not adversely affect the extrusion property during molding, so the technical significance of lowering the inorganic matter entrainment rate to lower than this level is small. The particularly preferred inorganic matter content range in this invention is therefore in the range of 0.5˜5 mass %.

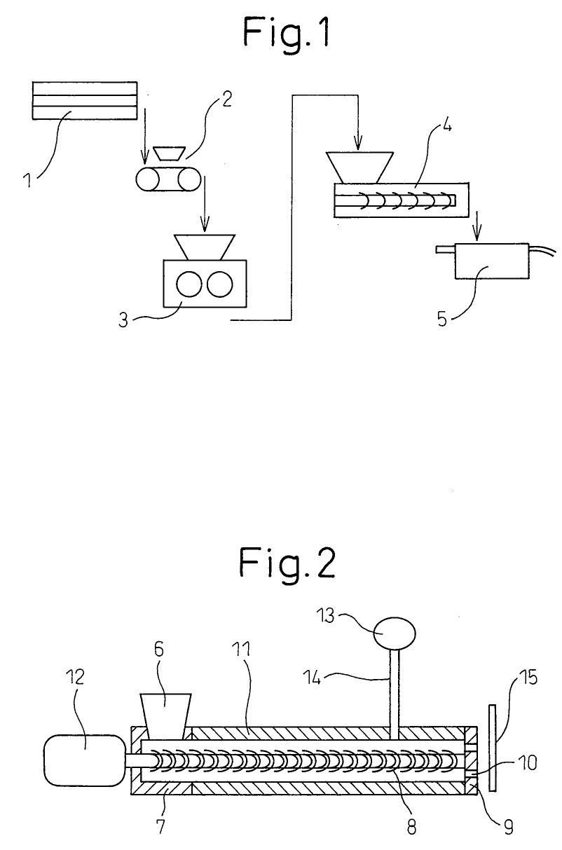

An exemplary embodiment of a waste plastic processing equipment suitable for carrying out these operations is shown in FIG. 1. After removal of inorganic matter by a vibrating sieve 1 and a magnetic separator 2, the waste plastic feedstock is crushed to a size of about 10˜50 mm or smaller by a crusher 3. The crushed plastic pieces can be \ supplied to a molding machine 4 and molded. The molded product is cut into short lengths and cooled to room temperature in a cooler 5 to obtain pellets.

An example of a molding machine for implementing the exemplary embodiment of the present invention is shown in a side cross-sectional view of FIG. 2. In this exemplary figure, the molding machine, designated by a reference numeral 4, comprises a supply port 6, a casing 7, stuffing screw 8, end-plate 9, nozzle 10, electric heating element 11, motor 12, vacuum pump 13, exhaust pipe 14 and cutter 15. The stuffing screw 8 can be driven by a rotational output of the motor 12 to rotate in the direction of extruding the plastic from the nozzle 10. The waste plastic pieces can be fed into the casing 7 through the supply port 6. Inside the casing 7, the waste plastic pieces are progressively forced inward and compacted by the stuffing screw 8.

The frictional heat generated at this time and heat from the electric heating element 11 may be used to heat the waste plastic to about 180˜260° C. Thermoplastic resins like polyethylene, polypropylene and polystyrene melt at this temperature. The content of polyethylene, polypropylene, polystyrene and the like may be about 50 mass % or greater. When their content is lower than this, the portion thereof in a molten state decreases to degrade cohesion during molding. However, when the content of polyethylene, polypropylene, polystyrene and the like exceeds 90 mass %, the resistance at the molding machine nozzles diminishes to lower the force of plastic compaction. The content is therefore preferably not greater than 90 mass %.

The temperature of the waste plastic in the molding machine can be regulated to within the range of about 180˜260° C. The temperature of the waste plastic is decided within this range based on the content ratios of the plastic constituents. When the content of thermoplastic resins is high or when the content of polyethylene, a thermoplastic resin having a low melting point, is high, a low temperature in the approximate range of about 180˜200° C. is used. When the content of thermoplastic resins is low or when the content of polypropylene and the like, i.e., of thermoplastic resins having a high melting point, is high, a high temperature in the approximate range of about 200˜260° C. may be used.

When the temperature is below the exemplary ranges described above, the viscosity of the plastic is high, making it hard to mold and also making it hard to remove the gas component entrained by the compacted plastic. As a result, the post-molding density may not increase. For example, when the temperature is below 180° C., the portion in a liquid state is small even when much low-melting-temperature polyethylene is present, so that high density may not be achieved. On the other hand, when the temperature is above the foregoing ranges, e.g., when it exceeds about 260° C., gas can generate from some of the plastic, making the amount of gas in the fluid plastic excessive and again keeping the density from becoming high. An exemplary problem that can arises when the temperature exceeds about 260° C. may be that chlorinated resins like polyvinyl chloride and polyvinylidene chloride actively generate hydrogen chloride gas. This generation of hydrogen chloride gas can swell the product pellets, so that they may not achieve a high apparent density. And since hydrogen chloride gas is highly corrosive, processing at not higher than 260° C. so to suppress hydrogen chloride generation is also preferable from the viewpoint of equipment maintenance.

Under these exemplary conditions, the waste plastic can assume a state in which the liquid portion accounts for about 50˜90% and the solid and low-fluidity portions account for about 10˜90%, so that the plastic becomes fluid as a whole. In this exemplary condition, gas can be incorporated into the waste plastic kneaded by the stuffing screw 8 owing to trapping of entrained gas, evaporation of water adhering to the waste plastic from before molding, and vaporization of some plastic constituents. If this situation is not dealt with, pores come to be present in the cut and cooled pellets. The apparent density of the cooled pellets decreases as a result. This can be prevented by extracting gas from the fluid plastic through the exhaust pipe 14 connected to the vacuum pump 13. The suction pressure of the casing 7 may be preferably reduced to below atmospheric pressure. In ordinary processing, the suction pressure at this time can be made about 0.1˜0.5 atm.

For example, in processing plastic including vinyl chloride or the like, or when the molding machine is one having a high production capacity of 1 ton/hr or greater, the pressure needs to be maintained relatively low. Specifically, when chlorinated resin is mixed in at a ratio of 4 mass % based on chlorine, the pressure should be kept in the range of 0.1˜0.35 atm. The viscosity of fluid plastic is high, so that even when the viscosity is lowered by high temperature, extraction of gas takes too much time unless the pressure is 0.5 atm or less, making it impossible to extract gas completely while the fluid plastic resides in the molding machine. However, when the suction pressure is too low, a problem may arise of inducing excessive gas generation with pressure reduction, so the suction pressure is best controlled to about 0.1 atm or greater. Under condition of high production capacity, when the temperature is in the range of 180˜200° C., i.e., under low-temperature condition, a suction pressure in the range of about 0.1˜02 atm can be preferable because the plastic viscosity is high. At about 200˜260° C., the viscosity of the plastic is relatively low and a suction pressure in the range of about 0.12˜0.35 atm is therefore especially preferable. In the case of conducting unified pressure control for producing high-density pellets having an apparent density of around about 0.9 kg/L or greater even when temperature varies, suction pressure in the range of about 0.1˜0.2 atm may be preferable. This is particularly effective when the chlorinated resin content can be about 0.5 mass % or greater on a chlorine basis.

The fluid plastic can be extruded from the nozzle 10. A nozzle diameter of about 15˜60 mm can be desirable. When the nozzle diameter is less than about 15 mm, solids and low-fluidity portions in the fluid plastic tend to increase friction with the nozzle and nozzle clogging tends to occur as a result. When the nozzle diameter exceeds about 60 mm, the velocity at which the fluid plastic can pass through the nozzle becomes too fast, so that plastic density increase in the casing may be inadequate. As a result, the apparent density fails to rise. Moreover, in the case of extruding from multiple nozzles, the large variance in the viscosity at different regions of the fluid plastic makes a special operation necessary for ensuring uniform extrusion of plastic from all nozzles. Most suitably, the cutter 15 is one of rotary type having a blade with a sharp edge angle (e.g., preferably about 30 degrees or less). This can be because a sharp blade is necessary for cutting fluid plastic.

An experiment has been conducted using nozzles of about 15˜60 mm diameter, from which they learned the following. In order to achieve suitable distribution of the fluid plastic, the nozzles can be spaced apart and the optimum spacing is related to the diameter of the stuffing screw 8. A quantitative analysis of the relationship revealed that suitable ranges exist for the diameter of the stuffing screw 8, the nozzle diameter and the number of nozzles, and that molding goes well when the ratio of the diameter of the stuffing screw 8 to the product of nozzle diameter times number of nozzles is equal to or less than a certain value. On the other hand, in order to achieve uniform distribution of the fluidized plastic in the exemplary embodiment of the present invention, the number of nozzles installed can be 8 or less. When multiple nozzles, e.g., about 2˜8 nozzles, are installed, a design that makes the sum of the nozzle diameters (nozzle diameter×number of nozzles) ¼ or less the circumferential length is effective. In an exemplary configuration using a pair of stuffing screws 8 (dual screw configuration), the sum of the nozzle diameters should be ⅙ or less the sum of the screw circumferences.

The plastic extruded from the nozzles is cut by the cutter 15 to produce plastic chunks whose length can be about 1˜3 times the diameter of the nozzle 10. The chunks may be cooled immediately after cutting to produce room-temperature plastic pellets. If the start of cooling is delayed or the cooling rate is slow, gas remaining in the chunks expands to swell the pellets. This makes it impossible to produce the high-density pellet that is the object of the present invention. The reason for this is that immediately after cutting, the plastic is still fluid and contains residual gas inside. The fluid plastic can therefore be rapidly cooled and solidified. The cooling is therefore commenced immediately after cutting. As the cooling method, there may be adopted a water cooling method that can achieve a rapid cooling rate.

Upon examining the plastic chunks while still fluid after cutting, the inventors found that swelling by residual gas becomes barely observable from about 2 seconds after cutting and is pronounced after passage of 6˜8 seconds after cutting. This is because the swelling by the internal gas is delayed owing to the high viscosity of the chunk. Under suitable exemplary conditions, thorough solidification of the plastic to a depth of about 2 mm from the surface is possible within 2 seconds. Swelling can be inhibited by quickly forming a solidified surface layer of about 2 mm or greater thickness. After cutting, it is therefore desirable to start water cooling within 3 seconds so as to form a solidified layer to a depth of 2 mm from the surface within 6 seconds of cutting. This exemplary method facilitates a production of high-density pellets with no swelling. On the other hand, experiments have been conducted in which, for example, water of a temperature of or below around 50° C. was poured onto plastic chunks in the fluid condition. As a result, it was determined that the above-described condition can be achieved insofar as the surface temperature of the pellets can be decreased to about 80° C. or lower within about 3 seconds of cutting.

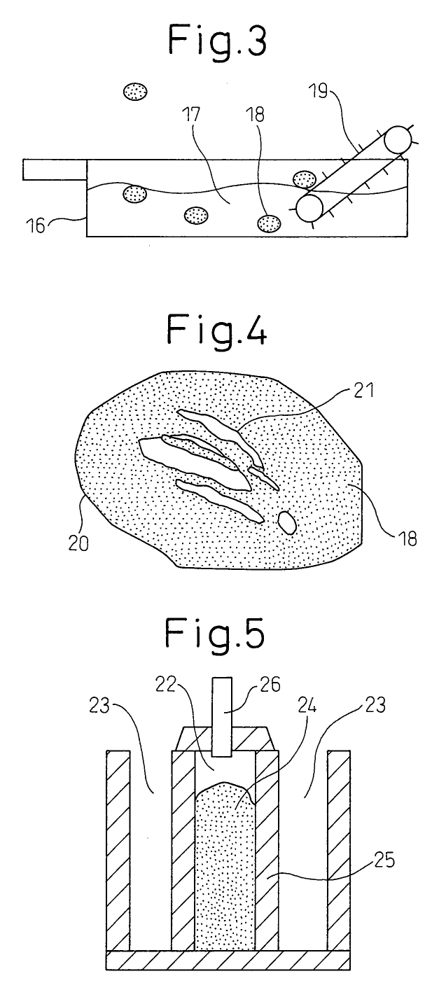

As the specific method of cooling, it is desirable to use the method of immersing the chunks in water, the method of pouring a large quantity of running water onto the chunks, or the method of spraying water onto the blocks. Moreover, for achieving the aforesaid condition, an adequate solidified surface layer can be formed within the time frame required by the present invention provided that, as strong water cooling, the cooling rate is 10˜60° C./min in terms of the temperature average for the whole cross-section. Suitable methods for this can be to immerse the fluid plastic blocks in water of a temperature not higher than about 50° C., spray them with water of a temperature not higher than about 50° C., or immerse them in running water of a temperature not higher than about 65° C. and a flow rate of not less than about 1 m/sec. For example, the exemplary embodiment method shown in FIG. 3 can be adopted. A water tank 16 is filled with water 17 and pellets (chunks) 18 are cast into the water. The temperature of the water 17 is controlled by the circulation cooling exemplary method, the cold water makeup method or other such method. The cooled pellets 18 are withdrawn with a conveyor 19 and dewatered to obtain the final exemplary product.

The internal structure of a pellet produced by the foregoing exemplary method is shown in FIG. 4. For example, the surface 20 can be smooth because the pellet was cooled from the molten state. Although layer-like pores 21 can be present internally, the pores occupy only around about 5˜15% of the pellet volume. Moreover, where the exemplary pellet is one having a characteristic length (defined as cube root of volume) of 50 mm, the pore thickness is about 2˜5 mm. Pellets meeting these conditions may not disintegrate or deform during transport. The apparent densities of pellets obtained in a production experiment conducted by the inventors were in the range of about 0.85˜1.1. The exemplary embodiments of the present invention facilitates a routine production of pellets with apparent density on this order. The high densities obtained by the exemplary embodiments of the present invention are about 1.2˜1.5 fold those by conventional methods.

The pellets can be mixed with coal. The mixing ratio is made about 5 mass % or less based on the quantity of coal. This can be because at a mixing ratio greater than 5 mass %, many cracks occur in the coke chunks formed by thermal decomposition and vaporization and the yield of high-value lump coke usable in a blast furnace or cupola furnace decreases. This exemplary phenomenon also occurs in low-density pellets and in such case occurs even when the mixing ratio can be about 5 mass % or less. Since the pellets produced by the method of the exemplary embodiment of the invention can be highly densified, they offer the merit of making this phenomenon unlikely to arise.

As coal is used a mixture of caking coal and ordinary coal crushed to about 5 mm or less. A predetermined quantity of pellets and coal are mixed by a method that makes the mixture as uniform as possible. The exemplary mixture is supplied to a coke oven as shown in FIG. 5. The exemplary mixture 24 can be supplied into the carbonization chamber 22 is gradually heated by heat from the heating chambers 23 on opposite sides. It can be dry-distilled from the surrounding carbonization chamber wall 25. Thermal decomposition reaction can start from the time when the plastic pellets reach a temperature of about 250° C. or greater. The plastic can be converted to hydrogen, carbon monoxide, methane, ethane, benzene and other volatile hydrocarbon components that rise to the top of the carbonization chamber. 22 to be recovered through a recovery pipe 26. The volatile components are then cooled and thereafter dechlorinated, desulfurized and gas-liquid separated into combustible gases and oily products. Carbon component remaining in the carbonization chamber 22 can heated to a maximum temperature of about 1,100˜1,200° C. to coalesce coke derived from coal. The optimum dry distillation period can be about 18˜24 hours. As carbon derived from plastic lacks viscosity, the coke strength at the interface between the plastic pellets and the coal is weak. The mixing ratio and properties of the pellets therefore affects coke quality.

Experiments showed the pellets of the exemplary embodiments of the present invention to have the following three characteristics. First, owing to their high density, they are advantageous in that for any given mass the pellet-coal volume ratio within the coal is low. Second, they have no pores or cracks extending from the surface to the interior, so that water does not seep into their interiors during storage or at the time of mixture with coal. And third, they have the merit of experiencing minimal swelling with temperature rise when supplied into the coke oven. These physical characteristics help to improve the coking conditions.

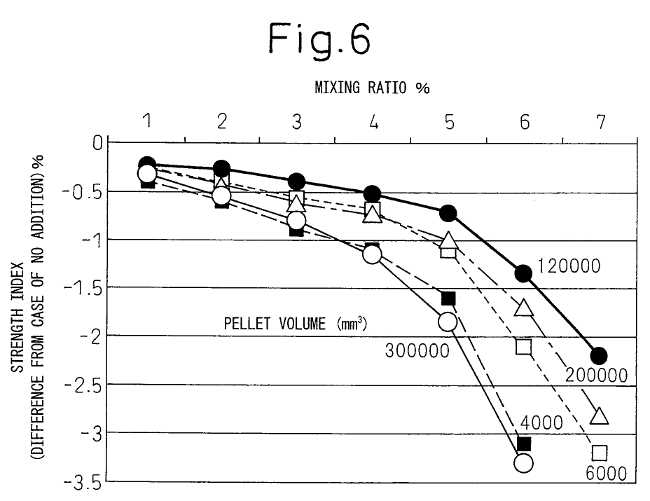

Because the exemplary pellets according to the exemplary embodiments of the present invention are high in density give them the advantage of small interface area even when the amount of waste plastic being mixed with the coal is the same as that when using low-density plastic pellets produced by a conventional method. Low strength portions of the produced coke can therefore be minimized. FIG. 6 shows the results of an investigation into how coke strength varies as a function of pellet mixing ratio for cokes produced from mixtures obtained by mixing coal and pellets of various volumes. The densities of the plastic pellets were in the range of about 0.9˜1.05 kg/L. When pellet volume was less than about 6,000 cubic mm, the effect of this invention was small because the interface between waste plastic and coal was large despite the high density of the pellets. When pellet volume was greater than about 200,000 cubic mm, waste plastic thermally decomposed to increase the size of internal voids after extraction of volatile components (combustible gas components and oily products). When the voids were large, the coke produced was, as expected, low in strength. The upper limit of pellet volume can therefore be 200,000 cubic mm. It was thus found that little lowering of coke strength is experienced when the pellet volume is in the range of 6,000˜200,000 cubic mm (nozzle diameter is in the approximate range of about 15˜60 mm). The strength index used in FIG. 6 implies that effects such as lowered iron productivity appear when the strength index of the coke used in the blast furnace is lower than that of coke produced in an ordinary operation by about 1% or greater.

Another exemplary condition is for the surface and interior of the pellets not to be interconnected by spaces, i.e., for there to be no holes or cracks passing from the surface into the interior. When internal voids connected to the exterior can be present, moisture contained in the coal invades to the interior of the pellets during pellet-coal mixing. Then when the pellets are supplied to a high-temperature region of the furnace, the internal moisture rapidly evaporates to disturb the charged state of the coal in the vicinity of the pellets. An important condition for producing high strength coke is therefore to avoid invasion of water into the pellet interior. Entry of water into the pellets occurs when the moisture content of the coal is 4 mass % or greater.

Under a temperature condition of about 100˜200° C. reached following supply of the pellets into the furnace, the plastic softens and air inside expands. The resulting increase in the volume of the pellets at this temperature lowers the effective density of the pellets. This is a problem because it diminishes the effect of the invention, which is directed to producing high-density pellets. From this it follows that constraining the size of the internal pores (closed pores) has a favorable effect on coke production results. Preferably, therefore, the maximum length of each individual pore present in a plastic pellet is not greater than the characteristic length (defined as the cube root of plastic pellet volume) and individual pore volume is not greater than 10% of the plastic pellet volume.

### EXAMPLES

### Example 1

Waste plastic pellets produced by the method of this invention using waste plastic (Feedstock 1) of the composition shown in Table 1 were thermally decomposed in a coke oven. Feedstock 1 consisted of waste plastic recovered from a production process at a plastic processing factory. It contained 56 mass % of polyethylene and 13 mass % of polypropylene, for a total combined content of polyethylene and polypropylene of 69 mass %. No vinyl chloride or other chlorinated resin was mixed into the waste plastic. In Table 1, the symbols PE, PP and PS stand for polyethylene, polypropylene and polystyrene, respectively.

TABLE 1
(In mass %)

| | PE | PP | PS | Other | Cl |
|---|---|---|---|---|---|
| Feedstock 1 | 56 | 13 | 0 | 31 | 0 |
| Feedstock 2 | 31 | 18 | 4 | 47 | 2.2 |
| Feedstock 3 | 51 | 19 | 8 | 22 | 0 |

The mixed plastic was crushed into pieces of a maximum length of 25 mm and processed in a molding machine of the type shown in FIG. 2. The molding machine was equipped with a single stuffing screw and a single 25 mm diameter nozzle. It had a processing rate of 1.0 ton/hr and permitted processing temperature selection at 10° C. intervals in the range of 180˜260° C. At processing temperature of 180° C., the suction pressure was set to 0.115 atm because the plastic fluidity was low. Further, the suction pressure was set to 0.14 atm when the processing temperature was 190° C., to 0.155 atm when it was 200° C., to 0.165 atm when it was 210° C., and to 0.18 atm when it was 260° C. The fluid plastic exiting the molding machine nozzle was cut and cast into 45˜55° C. running water within 1.5˜2.8 seconds after cutting. The running water channel had a width of 250 mm and depth of 150 mm. The water flow rate was 1.5 m/sec. The products (pellets) obtained by the processing had a volume of 16,000˜25,000 cubic mm and an apparent density of 0.91˜1.02 kg/L. Detailed data is shown in Table 2. Thus the pellets obtained by the operation method of the invention had high density.

Pellets obtained by the invention (e.g., Products 1˜5) were subjected to recycle processing in a coke oven. The pellets had smooth surfaces and no cracks or holes extending into the interior. The maximum length of the closed pores was 2-10 mm in all pellets and none exceeded ½ the characteristic length. The volume of independent voids was 3˜7% of pellet volume. The pellets were combined with coal at a mixing ratio of 2.3 mass %, mixed until substantially uniform, and supplied to the carbonization chamber of the coke oven. The processing period was 20 hours and the processing temperature at was 1,160° C. at its peak time point. The amounts of combustible gas and oily products obtained per ton of plastic under these conditions were 440 kg and 350 kg, respectively. About 190 kg was converted to coke, which was mixed and integrated with the coke derived from coal. The strength index of the coke was: (No addition value) −0.52˜−0.78%. Thus, even at a relatively large mixing ratio of 2.3%, the decline in coke strength was small. The strength index indicates the rate of occurrence of 15 mm or finer particles after tumbling for 150 revolutions at 15 rpm in an abrasion tester. Comparison was made with the case of no addition of waste plastic pellets.

TABLE 2

| | | Product | Product | Product | Product | Product |
|---|---|---|---|---|---|---|
| | Unit | 1 | 2 | 3 | 4 | 5 |
| Processing | ° C. | 180 | 190 | 200 | 210 | 260 |
| temperature | | | | | | |
| Suction pressure | Atm | 0.115 | 0.14 | 0.155 | 0.165 | 0.18 |
| Time to water- | Sec | 1.5 | 1.6 | 2.7 | 1.9 | 2.6 |
| cooling | | | | | | |
| Water temperature | ° C. | 45 | 45 | 51 | 50 | 55 |
| Pellet volume | mm³ | 25000 | 24000 | 16000 | 24000 | 21000 |
| Pellets apparent | g/cm³ | 1.02 | 0.99 | 0.91 | 0.92 | 0.91 |
| density | | | | | | |
| Product coke | Difference vs no | −0.52 | −0.61 | −0.71 | −0.69 | −0.78 |
| strength index | addition % | | | | | |

In contrast, the apparent density of pellets produced by a conventional method was 0.61 g/cm³. The volume was 30,000 cubic mm. These pellets were also mixed with coal at a mixing ratio of 2.3% and recycle-processed. The amounts of combustible gases and oily products with these pellets were the same as those in Example 1. The strength index of the obtained coke was: (No addition value)-1.25%. Thus, even at the same mixing ratio, the coke strength index was markedly lower for the conventional low-density pellets.

### Example 2

Waste plastic pellets produced by the method of this invention using waste plastic (Feedstock 2) of the composition shown in Table 1 were thermal decomposed in a coke oven. Feedstock 2 consisted of waste plastic in the form of containers/packaging and other articles of daily use recovered from households. It contained 31 mass % of polyethylene, 18 mass % of polypropylene and 4 mass % of polystyrene, for a total combined content of polyethylene, polypropylene and polystyrene of 53 mass %. The content of chlorine as a constituent of vinyl chloride and other chlorinated resins was 2.2 mass %.

The mixed plastic was crushed into pieces of a maximum length of 25 mm and processed in a molding machine of the type shown in FIG. 2. The molding machine was equipped with a single stuffing screw and two 40 mm diameter nozzles. The diameter of the stuffing screw 8 was 160 mm. The product of the number of nozzles times the nozzle diameter was 80 mm and thus smaller than ¼ the circumference of the stuffing screw 8. The processing rate was 1.2 ton/hr and the processing temperature was 200° C. The suction pressure was set to 0.21 atm. The fluid plastic exiting the molding machine nozzles was cut and cast into 40° C. still water 1˜1.2 seconds after cutting. The product (pellets) obtained by the processing had a volume of 140,000 cubic mm and an apparent density of 0.97 kg/L.

The 140,000 cubic mm pellets obtained by the invention were subjected to recycle processing in a coke oven. The processing conditions were the same as in Example 1. The pellets were combined with coal at a mixing ratio of 2.8 mass %, mixed until substantially uniform, and supplied to the carbonization chamber of the coke oven. The strength index of the so-processed coke was: (No addition value) −0.68%. Thus, the decline in coke strength was small.

### Example 3

Waste plastic pellets produced by the method of this invention using waste plastic (Feedstock 3) of the composition shown in Table 1 were thermal decomposed in a coke oven. Feedstock 3 consisted of waste plastic in the form of containers/packaging and other articles of daily use recovered from households. It contained 51 mass % of polyethylene, 19 mass % of polypropylene and 8 mass % of polystyrene, for a total combined content of polyethylene, polypropylene and polystyrene of 78 mass %.

The mixed plastic was crushed into pieces of a maximum length of 50 mm and processed in a molding machine of the type shown in FIG. 2. The molding machine was equipped with a pair of 196 mm diameter stuffing screws and four 38 mm diameter nozzles. The product of the number of nozzles times the nozzle diameter was 152 mm and thus smaller than ⅙ the circumference of the stuffing screw 8. The processing rate was 2.4 ton/hr and the processing temperature was 185° C. The suction pressure was set to minus 0.11 atm. The fluid plastic exiting the molding machine nozzles was cut and cast into 40° C. still water 1 second after cutting. The product (pellets) obtained by the processing had a volume of 76,000 cubic mm and an apparent density of 0.99 kg/L.

The 76,000 cubic mm pellets obtained by the processing were subjected to recycle processing in a coke oven. The processing conditions were the same as in Example 1. The pellets were combined with coal at a mixing ratio of 2.8 mass %, mixed until substantially uniform, and supplied to the carbonization chamber of the coke oven. The strength index of the recycle-processed coke was: (No addition value) −0.38%. Thus, thanks in part to the large pellet size, the decline in coke strength was particularly small.

### INDUSTRIAL APPLICABILITY

The present invention enables economical production of plastic pellets of high density and low powdering property. Moreover, since the pellets produced by the method explained in the foregoing are about 1.2˜1.5 times denser than those of pellets according to the prior art, they are highly useful for plastic recycling in a coke oven because, under any given recycle processing conditions, they can be charged into the coke furnace at 1.2˜1.5 fold the rate of conventional pellets with no degradation of coke oven productivity.

The foregoing merely illustrates the exemplary principles of the present invention. Various modifications and alterations to the described embodiments will be apparent to those skilled in the art in view of the teachings herein. It will thus be appreciated that those skilled in the art will be able to devise numerous modification to the exemplary embodiments of the present invention which, although not explicitly shown or described herein, embody the principles of the invention and are thus within the spirit and scope of the invention. All publications, applications and patents cited above are incorporated herein by reference in their entireties.

1-10. (canceled)

11. A method for molding a waste plastic, comprising:
heating waste plastic that is a mixture of multiple types of plastic containing at least one thermoplastic resin including at least one of polyethylene, polypropylene or polystyrene in a total amount accounting for about 50 mass % or greater of the mixture to a temperature of about 180 to 260° C. in a molding machine for extruding the waste plastic from a nozzle;
applying suction for extracting a gas from the interior of the molding machine;
compression-molding the waste plastic by extruding it from the nozzle in this condition;
cutting the extruded waste plastic; and
cooling the cut waste plastic in a water cooler.

12. The method according to claim 11, wherein:
the waste plastic is a mixture of multiple types of plastic containing at least one thermoplastic resin including the polyethylene, polypropylene or polystyrene in a total amount accounting for about 50 mass % or greater of the mixture and the waste plastic contains a chlorine-containing plastic at the rate of not greater than about 5 mass % on a chlorine mass ratio basis is applied with a suction for extracting a gas by an exhauster generating reduced pressure of about 0.1-0.35 atm;
the waste plastic is compression-molded by extruding it from the nozzle in this condition;
the extruded waste plastic is cut; and
the cut waste plastic is cooled in a water cooler.

13. The method according to claim 11, wherein waste plastic chunks obtained by cutting the waste plastic extruded from the nozzle in a totally or partially molten state are water-cooled in a water cooler to reach a surface temperature of about 80° C. or less within about 2 seconds of the start of cooling.

14. The method according to claim 11, wherein the waste plastic is molded using the molding machine having a single stuffing screw and equipped with about 2-8 nozzles, and wherein a sum of the nozzle diameters which includes a nozzle diameter×number of nozzles is about ¼ or less a circumferential length of a stuffing screw.

15. The method according to claim 11, wherein the waste plastic is molded using the molding machine having a pair of stuffing screws and equipped with about 2˜8 nozzles, and wherein the sum of the nozzle diameters which is a nozzle diameter×number of nozzles is about ⅙ or less of the sum of a circumferential lengths of the stuffing screws.

16. A method for molding a waste plastic, comprising:
heating the waste plastic that is a mixture of multiple types of plastic containing at least one thermoplastic resin including polyethylene, polypropylene or polystyrene in a total amount accounting for about 50 mass % or greater of the mixture to a temperature of about 180-260° C. in a molding machine for extruding the waste plastic from a nozzle;
applying a suction for extracting gas from the interior of the molding machine;
compression-molding the waste plastic by extruding it from a nozzle of about 15˜60 mm diameter in this condition;
cutting the extruded waste plastic; and
cooling the cut waste plastic in a water cooler within about 3 seconds after the cutting procedure.

17. The method according to claim 16, wherein:
the waste plastic is a mixture of multiple types of plastic containing at least one thermoplastic resin including the polyethylene, polypropylene or polystyrene in a total amount accounting for about 50 mass % or greater of the mixture and the waste plastic contains a chlorine-containing plastic at the rate of not greater than about 5 mass % on a chlorine mass ratio basis is applied with a suction for extracting a gas by an exhauster generating reduced pressure of about 0.1-0.35 atm;
the waste plastic is compression-molded by extruding it from the nozzle in this condition;
the extruded waste plastic is cut; and
the cut waste plastic is cooled in a water cooler.

18. The method according to claim 16, wherein waste plastic chunks obtained by cutting the waste plastic extruded from the nozzle in a totally or partially molten state are water-cooled in a water cooler to reach a surface temperature of about 80° C. or less within about 2 seconds of the start of cooling.

19. The method according to claim 16, wherein the waste plastic is molded using the molding machine having a single stuffing screw and equipped with about 2-8 nozzles, and wherein a sum of the nozzle diameters which includes a nozzle diameter×number of nozzles is about ¼ or less a circumferential length of a stuffing screw.

20. The method according to claim 16, wherein the waste plastic is molded using the molding machine having a pair of stuffing screws and equipped with about 2˜8 nozzles, and wherein the sum of the nozzle diameters which is a nozzle diameter×number of nozzles is about ⅙ or less of the sum of a circumferential lengths of the stuffing screws.

21. A method for molding a waste plastic, comprising:
molding the waste plastic using a molding machine having a single stuffing screw and equipped with about 2-8 nozzles, wherein the sum of the nozzle diameters which is a nozzle diameter×a number of nozzles is about ¼ or less a circumferential length of the stuffing screw.

22. A method for molding waste plastic comprising:
using a molding machine having a pair of stuffing screws and equipped with 2˜8 nozzles, molding waste plastic by:
heating waste plastic that is a mixture of multiple types of plastic containing at least one thermoplastic resin including at least one of polyethylene, polypropylene or polystyrene in a total amount accounting for about 50 mass % or greater of the mixture to a temperature of about 180 to 260° C. in a molding machine for extruding the waste plastic from a nozzle,
applying suction for extracting a gas from the interior of the molding machine,
compression-molding the waste plastic by extruding it from the nozzle in this condition,
cutting the extruded waste plastic, and
cooling the cut waste plastic in a water cooler,
wherein the sum of the nozzle diameters (nozzle diameter×number of nozzles) is ⅙ or less of the sum of the circumferential lengths of the stuffing screws.

23. A method for a thermal decomposition of a waste plastic, comprising:
mixing coal and plastic pellets having (i) no holes or cracks passing from the surface into the interior, (ii) an apparent density of about 0.85-1.1 g/cm³, and (iii) a volume of about 6,000-200,000 cubic mm, and
thermal decomposing and vaporizing the obtained mixture in a coke oven.

24. The method according to claim 23, wherein:
the plastic pellets mixed with coal have a maximum length of each individual pore present therein which is at most as great as a cube root of a plastic pellet volume and an individual pore volume is at most about 10% of the plastic pellet volume; and
the obtained mixture is thermal decomposed and vaporized in a coke oven.

25. The method according to claim 23, wherein the plastic pellets produced by are mixed with coal; and wherein the obtained mixture is thermal decomposed and vaporized in a coke oven.

26. The method according claim 25, wherein the mixing ratio of the plastic pellets to coal is about 5 mass % or less.
